(19) United States
(12) Patent Application Publication
(10) Pub. No.: US 2013/0298347 A1
(43) Pub. Date: Nov. 14, 2013

(54) DEVICE FOR THE ARTICULATED CONNECTION OF A FLAT-BAR WIPER BLADE TO A WIPER ARM

(71) Applicant: Wim Verboven, Tessenderlo (BE)

(72) Inventor: Wim Verboven, Tessenderlo (BE)

(73) Assignee: ROBERT BOSCH GMBH, Stuttgart (DE)

(21) Appl. No.: 13/981,315

(22) PCT Filed: Dec. 27, 2011
(86) PCT No.: PCT/EP11/74109

§ 371 Date: Jul. 23, 2013

(30) Foreign Application Priority Data
Jan. 25, 2011 (DE) 10 2011 003 088.3
Feb. 9, 2011 (DE) 10 2011 003 838.8

(51) Int. Cl. B60S 1/40

(52) U.S. Cl. CPC B60S 1/4067
USPC 15/250.32

(57) ABSTRACT

The invention relates to a device for the articulated connection of a flat-bar wiper blade (10) to a wiper arm (28), said device comprising a connection element (16), with a bearing pin (20), to be connected to the wiper blade (10), a connecting element (30) connected to the wiper arm (28), and an adaptor (44) which is both pivotally mounted on the bearing pin (20), by means of a hub (54), as well as inserted in the connecting element (30) in a rigid but detachable manner using locking means (40, 76). According to the invention, the hub (54) has an assembly channel (56) along its entire length on the side which faces the bearing pin (20), with the play between the hub (54) and the bearing pin (20) being calculated such that moments about a vertical axis (88) are transmitted from the wiper blade (10) to the adaptor (44) exclusively by means of the bearing pin (20) and the hub (54), and vice versa.

### BACKGROUND OF THE INVENTION

The invention relates to a device for the articulated connection of a flat-bar wiper blade to a wiper arm.

A device for the articulated connection of a flat-bar wiper blade to a wiper arm is known from the German patent specification DE 103 47 637 A1. In this case, a connection element in the form of a sheet-metal claw has a central longitudinal web which faces away from the support element of the wiper blade and into which a transversely running bearing pin is inserted in a rotationally fixed manner. An adapter with bearing openings which are arranged in lateral spring tongues is mounted pivotally on the bearing pin, which projects in a floating manner on both sides of the longitudinal web. The adapter, which is manufactured from plastic, surrounds the sheet-metal claw from the outside and is clipped by means of latching elements and retaining elements into a connecting element which is open towards the wiper blade and is connected fixedly to the wiper arm. The adapter is both guided laterally on the sheet-metal claw by means of inner guide webs and inserted at the side walls thereof in a play-free manner in the connecting element.

The WIPO patent specification WO 02/40328A1 discloses a similar device. Said device comprises a connection element in the form of a sheet-metal claw, an adapter made from plastic and a connecting element which is fixedly connected to the wiper arm. The connection element is fastened to the support element of the wiper blade in the form of two parallel spring rails using claws and/or by means of welding. Said connection element has a U-shaped cross-sectional profile, wherein starting from a base part which is adjacent to the support element, side walls are bent away from said support element at an angle of approximately 90°. Openings, into which a bearing pin is inserted in a rotationally fixed manner, are provided in the side walls. The adapter, which is guided laterally between the side walls of the connection element, is mounted pivotally on the bearing pin by means of a hub.

In addition, a device for the articulated connection of a flat-bar wiper blade to a wiper arm is known from the German patent specification DE 20 2005 008 673 U1. The wiper arm extends in the flow direction of the airstream in front of the wiper blade and approximately parallel to the same. The connecting element is therefore correspondingly laterally offset. Because the wiper arm is spaced apart from the vehicle window pane at less distance than the top side of the connecting element, a step results in the extension of the connecting element, which step runs approximately parallel to the wiper arm in the longitudinal direction. In the connection to the adapter, a filler piece is disposed in the offset region, which piece rests in a sealing manner against the inner walls of the connecting element and against the facing end face of the adapter. The filler piece fills the hollow space between the adapter and the end of the wiper arm, which is designed as a wiper rod, and has a step analogous to the step of the connecting element. The filler piece serves to deflect the water flowing along the wiper arm at a certain distance between the device and the vehicle window pane.

### SUMMARY OF THE INVENTION

According to the invention, the hub has an assembly channel along its entire length on the side which faces the bearing pin, with the play between the hub and the bearing pin being calculated such that moments about a vertical axis are transmitted from the wiper blade to the adapter exclusively by means of the bearing pin and the hub, and vice versa. The bearing surfaces of the hub and the bearing pin can be easily and very precisely manufactured with little play and with good sliding properties, and therefore the same high-quality surfaces are provided for guiding the wiper blade as for mounting the same. In addition, the friction is reduced in the device so that the wiper blade can be adapted easily and in a wear-free manner to the different conditions during the wiping motion. This advantage can also be supported if support surfaces are disposed on the adapter between the same and the connection element in the proximity of the bearing surface of the hub in order to absorb forces in the longitudinal direction of the bearing pin. Said forces thereby affect a short lever arm so that the pivoting motion is not impaired.

According to one embodiment of the invention, the stability of the open hub is improved by ribs on the outer sides of the side parts of the adapter, which run radially with respect to the hub and radially support the same. It is thereby expedient for some ribs to be located opposite one another in pairs and to form an angle of approximately 90° to the other ribs. If the bearing pin during assembly is clipped into the hub by means of the assembly channel, the wiper blade can nevertheless be easily mounted to the wiper arm by the use of a sufficient resilience of the hub. According to a further embodiment of the invention, this results from the fact that the adapter has a recess which runs transversely to the longitudinal direction and parallel to the open hub on the side of the hub opposite to the assembly channel, said recess being open towards the top wall over the entire width of the adapter and extending over a circumferential region of the hub which covers up to 90° of the circumference. The adapter can thereby be disposed in an advantageous manner between two adjacent radial ribs.

A particularly advantageous connection between wiper blade and wiper arm results if, according to a further embodiment of the invention, the connection element is a sheet-metal claw which has a longitudinal web on the side thereof facing away from the wiper strip, at which web a bearing pin made from metal and serving as bearing element protrudes to both sides. In the assembled state, said longitudinal web engages in a longitudinal gap of the adapter with enough play that a torque about a vertical axis from the connection element to the adapter is transmitted by means of the bearing pin and the hub. In so doing, very stable individual components, which can be manufactured with minimal play, result.

In order to ease assembly, it is expedient for the connecting element to have an accommodating part with a U-shaped cross-section, in which the adapter can be inserted from the open side oriented towards the outer end of the wiper blade until a stop edge of the front end wall of said adapter abuts against a corresponding end face of the accommodating part, and a spring press-button on the top wall of said adapter engages in a corresponding opening in the accommodating part of the connecting element. This can occur in a manner which is as free of play as possible if, according to one embodiment of the invention, the spring press-button is connected to a rear end wall of the adapter via a parallel guide, which has two spring leaves running parallel to one another in the longitudinal direction towards the outer end of the wiper blade, the front part of the spring press-button and the parallel guide being accommodated in a recess of the top wall. When the spring press-button is pressed, said button is displaced in a straight line and not in the usual manner along a circular arc.

During the wiping operation, water flows from the inner, drive-side end to the outer end of the wiper arm and the wiper blade due to the centrifugal forces. Due to the swirling of the airstream, in particular in the region of the connection device, water is sprayed from the front side of the wiper blade onto the already wiped wiping surface on the back side of the wiper blade particularly during the downward motion of the windshield wiper, whereby the wiping performance is impaired. In order to reduce the swirling and to prevent the disadvantages caused thereby, a lug pointing in the longitudinal direction is provided according to one embodiment of the invention on the side of the front end wall of the adapter facing the outer end of the wiper blade. The swirling of the air is prevented by the lug and the water is deflected in the longitudinal direction of the wiper blade.

This is particularly advantageous if the hollow spaces of the adapter are also covered by smooth surfaces towards the vehicle window pane. As a result, eddies are prevented on the one hand and secondly no water can collect in the hollow spaces. The same effect is achieved with a connecting element, the accommodating part of which extends via a cranked portion offset to the connection part in a laterally parallel manner and the cranked portion forms a step extending in the longitudinal direction between the accommodating part and the connection part, by a filler piece being integrally formed on the rear end wall of the adapter, said filler piece fitting into the dead space of the connecting element, said dead space being contiguous to the step.

### BRIEF DESCRIPTION OF THE DRAWINGS

Further advantages ensue from the following description of the drawings. Exemplary embodiments of the invention are depicted in the drawings. The drawings, the description and the claims contain numerous features in combination. The person skilled in the art will also consider the features individually and put them together to form further useful combinations.

In the drawings:

FIG. 1 shows a side view of an adapter of a device according to the invention;

FIG. 2 shows a perspective view of an adapter pursuant to FIG. 1 from above;

FIG. 3 shows a perspective view of an adapter pursuant to FIG. 2 from below;

FIG. 4 shows a perspective view of an adapter pursuant to FIG. 2 in a tilted position at an angle from above;

FIG. 5 shows a perspective partial view of a wiper blade comprising a connection element of a device according to the invention;

FIG. 6 shows a perspective view of a device according to the invention on a supporting element;

FIG. 7 shows a perspective view of a connecting element which includes an adapter of a device according to the invention from below; and

FIG. 8 shows a schematic longitudinal section parallel to a support element through a pivot axis of a bearing pin.

### DETAILED DESCRIPTION

A wiper blade 10 comprises a wiper strip 12, which is held by a support element 14 in the form of two spring rails which are pre-curved in a concave manner with respect to the wiper strip. The support element 14 is embedded in lateral longitudinal grooves of the wiper strip 14. A connection element 16 in the form of a sheet-metal claw is fastened by means of claws 24 or welded to the support element 14 in a central region thereof. Spoiler parts are mounted to said support element 14 on both sides of the connection element 16.

The wiper blade 10 is connected in an articulated manner to a wiper arm 28 by means of a device. The device comprises the connection element 16, an adapter 44 and a connecting element 30 which is fixedly connected to the wiper arm 28.

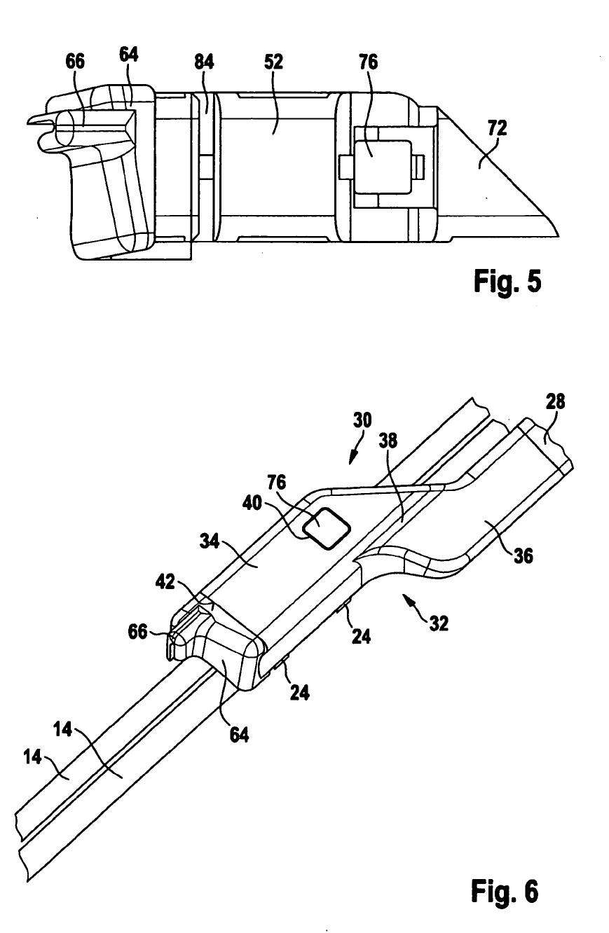

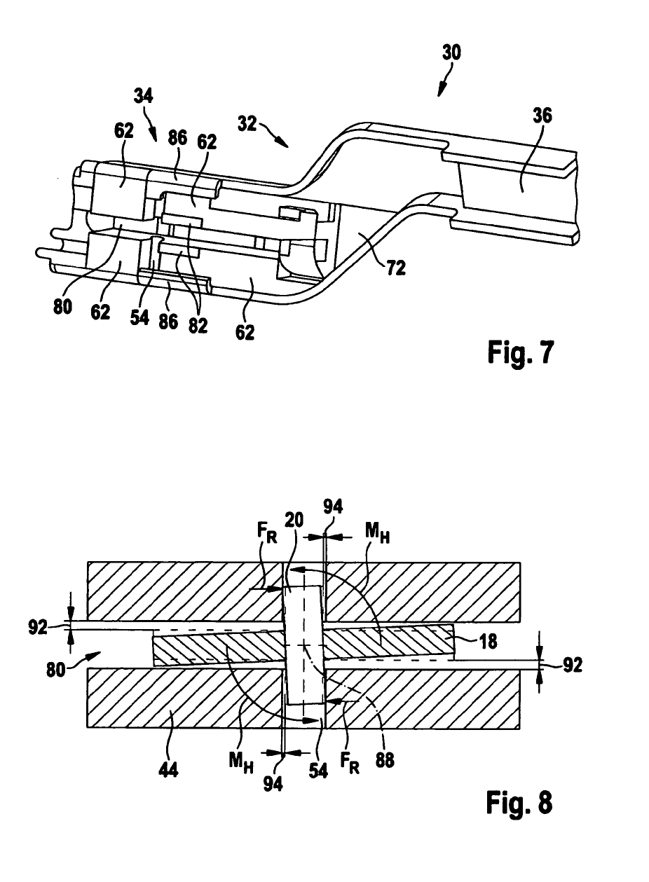

The connection element 16 in the embodiment pursuant to FIG. 5 has a base part 22 which supports a longitudinal web 18 on the side thereof facing away from the wiper strip 12. A bearing pin 20 is inserted transversely to the longitudinal direction into the longitudinal web 18, said bearing pin protruding to some extent on both sides of said web. The claws 24 are integrally formed on the side of the base part 22 and laterally encompass the support element 14.

The adapter 44 has two side parts 46 which are connected to one another by means of a front end wall 64, a rear end wall 70, a top wall 52 and a base 60. In addition, the adapter 44 comprises a hub 54, which extends over the entire width of said adapter 44 and has an assembly channel 56 extending parallel to said hub 56 on the side thereof facing the wiper strip 12. Said assembly channel tapers towards the hub 54 up until a narrowest point 58 located at a short distance from the bearing surface of the hub 54. During assembly, the bearing pin 20 is clipped through the assembly channel 56 and across the narrowest point 58 into the hub 54. In so doing, the narrowest point 58 yields elastically. In order to improve the resilience in this direction, the adapter 44 has a recess 84, which extends parallel to the hub 54 and is open towards the top wall 52, on the side thereof facing away from the assembly channel 56. In order to achieve a good transmission of force from the bearing surfaces of the hub 54 to the adapter 44, the side parts 46 are reinforced with ribs 48, 50 on the exterior sides thereof. The ribs 48, 50 extend radially with respect to hub 54, wherein the ribs 48 are located opposite to one another and the ribs 50 together with said ribs 48 include an angle of up to 90°.

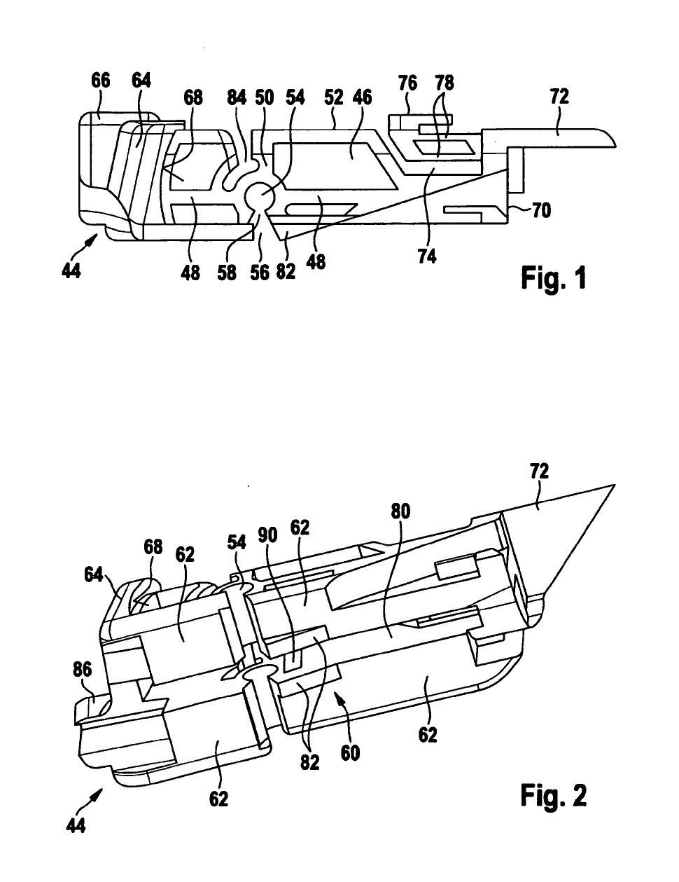

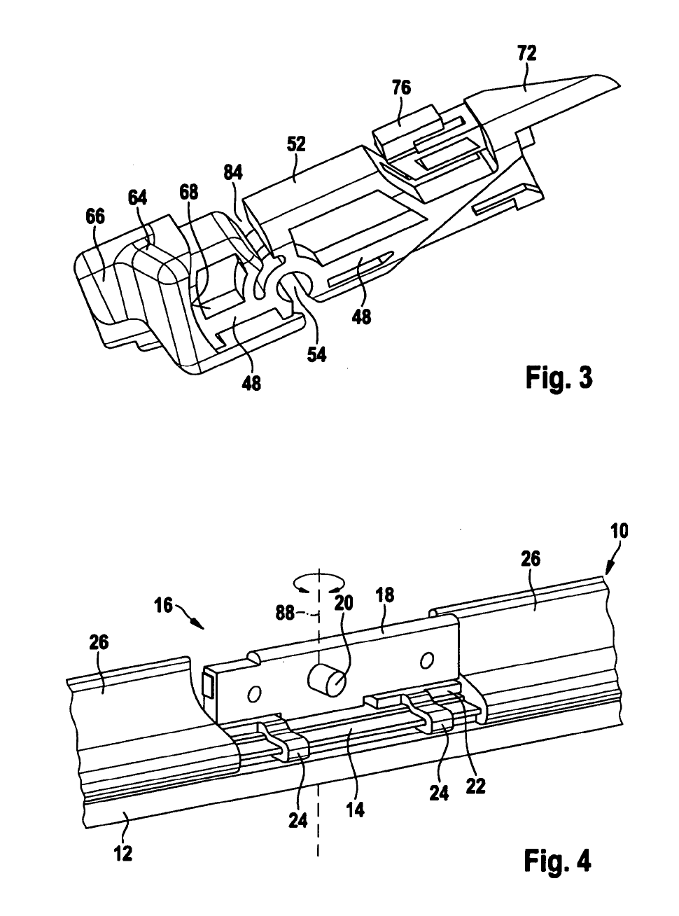

The recess 84 lies between two adjacent ribs 48, 50 and encompasses the hub 54 in a circumferential region up to 90°. As a result of this measure, the bearing forces and guiding forces are transmitted more precisely to the adapter 44 without the moments about a vertical axis 88 being transmitted from the adapter 44 to the longitudinal web 18, which engages in the assembled state in a longitudinal gap 80 of the adapter 44. The bearing play 84 between the bearing pin 20 and the hub 54 is calculated in relation to the play 92 between the longitudinal web 18 and the longitudinal gap 80 such that the torsional moments M_{H} about the vertical axis 88 are transmitted exclusively via the contact surfaces between the hub 54 and the bearing pin 20. The force couple of the resulting forces F_{R} acting on the contact surfaces of the hub 54 forms a moment (FIG. 8) that counteracts the torsional moment. As a result, the hub 54 and the bearing pin 20 assume a guiding function besides the bearing function of the joint, the precision being ensured by the exactness of the bearing surfaces. In so doing, the friction is minimized between the longitudinal web 18 and the longitudinal gap 80, the free movement of the joint is improved and wear is reduced. Only forces in the longitudinal direction of the bearing pin 20 are supported via the support surfaces 90 on the inner sides of the longitudinal gap 80, which are provided in the proximity of the hub 54 (FIG. 2). The support surfaces 90 could also be provided on the longitudinal web 18 in the proximity of the bearing pin 20.

In order to restrict the pivoting motion of the adapter 44 as little as possible on the drive-side, inner side of the wiper blade 10, the base 60 on this side of the hub 54 is offset to some extent towards the top wall 52. In order to nevertheless ensure a secure assembly of the bearing pin 20 through the assembly channel 56, wedge-shaped reinforcements 82, which are reduced in height towards the inner end of the adapter 44, are situated on the base 60 in the proximity of the longitudinal gap 80.

The connecting element 30 has an accommodating part 34 for the adapter 44, said accommodating part being connected via a lateral cranked portion 32 to a connection part 36 offset in parallel. Said connecting element can be fixedly connected to the wiper arm 28 in a form-fitting, force-fitting or materially bonded manner, for example by means of crimping, welding or by means of an integral manufacture with the wiper arm 28. A step 38, which extends in the longitudinal direction of the wiper blade 10, is located at the transition between the connection part 36 and the accommodating part 34. The connection part 36 thereby extends towards the wiper strip 12 in an offset manner with respect to the accommodating part 34.

The accommodating part 34 has a profile which is U-shaped in cross-section and is open towards the outer end of the wiper blade 10. The adapter 44 is pushed into the accommodating part 34 from the open side until a stop edge 68 on the front end wall 64 of the adapter 44 rests against the end face 42 of the accommodating part 34 and a spring press-button 76 of the adapter 44 engages in an opening 40 of the accommodating part 34. The spring press-button 76 is partially accommodated in a recess 74 of the top wall 52 and is fastened via a parallel guide 78 in the form of two parallel spring leaves to the rear end wall 70 of the adapter. The button 76 thus does not move in a circular arc but in a straight line perpendicularly to the outer face of the top wall 52; thus enabling a precise tolerance to be maintained between the stop edge 68 and the button 76. The adapter 44 is held by the side of the accommodating part 34 facing the wiper strip 12 by means of guide angles 86 which are angled inwardly from the side walls of the accommodating part 34 and in the assembled state expediently extend across the assembly channel 56 in the longitudinal direction.

The base 60 of the adapter 44 has smooth surfaces 62 which cover the hollow spaces of the adapter towards the outside and thus prevent water from collecting in said hollow spaces. In addition, eddies are prevented from forming in these areas which could cause noises. A filler piece 72 serves the same purpose, which is integrally formed on the rear end wall 70 of the adapter 44 and in the assembled state fills a dead space of the accommodating part 34. The filler piece 72 can also be designed such that it protrudes to some extent into the connection part 36.

A lug 66 is provided on the front end wall 64 so as to point to the outer end of the wiper blade 10. By means of said lug, the airstream in the region of the device is deflected in the longitudinal direction of the wiper blade 10, whereby eddies are suppressed on the outside of the front end wall 64. During operation, in particular during the downward motion of the wiper blade 10, droplets on the back side of the wiper blade 10 are thus prevented from being sprayed onto the vehicle window pane.

1. A device for the articulated connection of a flat-bar wiper blade (10) to a wiper arm (28), said device comprising a connection element (16), with a bearing pin (20), to be connected to the wiper blade (10), a connecting element (30) connected to the wiper arm (28), and an adaptor (44) which is both pivotally mounted on the bearing pin (20) by means of a hub (54) as well as inserted in the connecting element (30) in a rigid but detachable manner using locking means (40, 76), characterized in that the hub (54) has an assembly channel (56) along an entire length of the hub on a side which faces the bearing pin (20), with play between the hub (54) and the bearing pin (20) being calculated such that moments about a vertical axis (88) are transmitted from the wiper blade (10) to the adapter (44) exclusively by means of the bearing pin (20) and the hub (54), and vice versa.

2. The device according to claim 1, characterized in that support surfaces (90) are disposed on the adapter (44) between the same and the connection element (16) in the proximity of the bearing surface of the hub (54) in order to absorb forces in a longitudinal direction of the bearing pin (20).

3. The device according to claim 1, characterized in that side parts (46) of the adapter (44) have ribs (48, 50) on the exterior sides thereof, said ribs extending radially with respect to the hub (54) and radially supporting the hub.

4. The device according to claim 3, characterized in that two of the ribs (48) are located opposite one another in pairs and form an angle of approximately 90 degrees to an other one of the ribs (50).

5. The device according to claim 1, characterized in that the connection element (16) is a sheet-metal claw, which has a longitudinal web (18) on a side thereof facing away from the wiper strip (12), at which longitudinal web a bearing pin (20) made from metal protrudes to both sides and which web, in an assembled state, engages in a longitudinal gap (80) of the adapter (44) with enough play that torsional moments about the vertical axis (88) are transmitted from the connection element (16) to the adapter (44) by means of the bearing pin (20) and the hub (54).

6. The device according to claim 1, characterized in that the connecting element (30) has an accommodating part (34) with a U-shaped cross-section, in which the adapter (44) can be inserted from an open side that is oriented towards an outer end of the wiper blade 10, and up until an end face (42) thereof abuts against a corresponding stop edge (68) of a front end wall (64) of the adapter (44) and a spring press-button (76) on a top wall (52) of said adapter (44) engages in a corresponding opening (40) in the accommodating part (34) of the connecting element (30).

7. The device according to claim 6, characterized in that the spring press-button (76) is connected to a rear end wall (70) of the adapter (44) via a parallel guide (78) which has two spring leaves extending parallel to one another in a longitudinal direction towards the outer end of the wiper blade (10), a front part of the spring press-button (76) and the parallel guide (78) being accommodated in a recess (74) of the top wall (52).

8. The device according to claim 6, characterized in that the adapter (44) has a recess (84) on a side of the hub (54) opposite to the assembly channel (56), which recess extends parallel to the hub (54), is open to the top wall (52) along an entire width of the adapter (44) and extends over a circumferential region of the hub (54) which covers up to 90 degrees of a circumference.

9. The device according to claim 6, characterized in that a lug (66) pointing in a longitudinal direction is provided on a side of the front end wall (64) of the adapter (44) which is oriented towards the outer end of the wiper blade (10).

10. The device according to claim 6, characterized in that part of a base (60) of the adapter (44) which starting from the hub (54) is oriented in a longitudinal direction towards an inner end of the wiper blade (10) extends somewhat offset to the top wall (52) with respect to a part oriented towards the outer end of the wiper blade (10), wherein at least one wedge-shaped reinforcement (82), a height of which decreases towards the inner end of the wiper blade (10), is provided on an inner part of the base (60) so as to adjoin the assembly channel (56).

11. The device according to claim 1, characterized in that a base (60) of the adapter (44) has smooth surfaces (62) towards a wiper strip (12), said smooth surfaces covering hollow spaces of the adapter (44).

12. The device according to claim 1, characterized in that the accommodating part (34) of the connecting element (30) extends via a cranked portion (32) offset to a connection part (36) in a laterally parallel manner, the cranked portion (32) forming a step (38), which extends in a longitudinal direction, between the accommodating part (34) and the connection part (36).

13. The device according to claim 12, characterized in that a filler piece (72) is integrally formed on a rear end wall (70) of the adapter (44), said filler piece fitting into a dead space of the connecting element which is contiguous to the step (38).
